(19) United States
(12) Patent Application Publication
(10) Pub. No.: US 2018/0268621 A1
(43) Pub. Date: Sep. 20, 2018

(54) USAGE-BASED VEHICLE LEASING AND OTHER SERVICES WITH A DONGLE MODULE

(71) Applicant: Continental Intelligent Transportation Systems, LLC, Santa Clara, CA (US)

(72) Inventors: Seval OZ, San Jose, CA (US); Tammer ZEIN-EL-ABEDEIN, Campbell, CA (US); Yao ZHAI, Fremont, CA (US)

(73) Assignee: Continental Intelligent Transporation Systems, LLC, Santa Clara, CA (US)

(21) Appl. No.: 15/761,954

(22) PCT Filed: Sep. 2, 2016
(86) PCT No.: PCT/US16/50078

§ 371 Date: Mar. 21, 2018

Related U.S. Application Data
(60) Provisional application No. 62/221,467, filed on Sep. 21, 2015.

(51) Int. Cl. G07C 5/00; G06F 17/30; G07C 5/08; G07C 5/02; G06Q 30/02; G06Q 30/06; G06Q 40/08; G06Q 10/00

(52) U.S. Cl. CPC G07C 5/006; G06F 17/30861; G07C 5/008; G07C 5/085; G06Q 10/20; G06Q 30/0278; G06Q 30/0645; G06Q 30/0283; G06Q 40/08; G07C 5/02

(57) ABSTRACT

An automated system for driver scoring and reporting maintains a performance history associated with particular drivers in a stored database of multiple drivers. An automated system tracks actual operation of the vehicle and maintenance performed on the vehicle to determine an estimated percentage of life remaining for the vehicle. The backend database stores the records of multiple vehicles. Services, such as i) usage-based vehicle leasing and ii) a certified life-expectancy of a vehicle, can use raw vehicle data and enriched vehicle data captured via a dongle module in the vehicle to determine the expected life remaining of that vehicle.

### FIELD

An aspect of the design is generally concerned with an automated system for driver scoring and reporting that maintains a performance history associated with particular drivers in stored database of multiple drivers. Another aspect is generally concerned with an automated system for tracking actual operation of the vehicle as well as maintenance performed on the vehicle to determine the estimated percentage of life remaining with this vehicle.

### BACKGROUND

Typically, physical key fobs are created and sold with a particular vehicle to allow remote access into the vehicle.

### SUMMARY

In an embodiment, a method and system are discussed for an automated system for driver scoring and reporting that maintains a performance history associated with particular drivers in stored database of multiple drivers. In another embodiment, a method and system are discussed for an automated system for tracking actual operation of the vehicle as well as maintenance performed on the vehicle to determine the estimated percentage of life remaining with this vehicle. The backend database stores the records of multiple vehicles. Services, such as i) usage-based vehicle leasing and ii) a certified life-expectancy of a vehicle, can use raw vehicle data and enriched vehicle data captured in a dongle module in the vehicle to determine the expected life remaining of that vehicle.

### BRIEF DESCRIPTION OF THE DRAWINGS

The multiple drawings refer to the example embodiments of the design.

FIG. 1 illustrates a block diagram of an example computing system that may be used in an embodiment of one or more of the servers, in-vehicle electronic modules, and client devices discussed herein.

FIGS. 2A and 2B illustrate diagrams of a network environment in which the techniques described may be applied.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific package delivery services, named components, connections, number of databases, etc., in order to provide a thorough understanding of the present design. It will be apparent; however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details discussed in one embodiment may be reasonably implemented in another embodiment. The specific details may be varied from and still be contemplated to be within the spirit and scope of the present design.

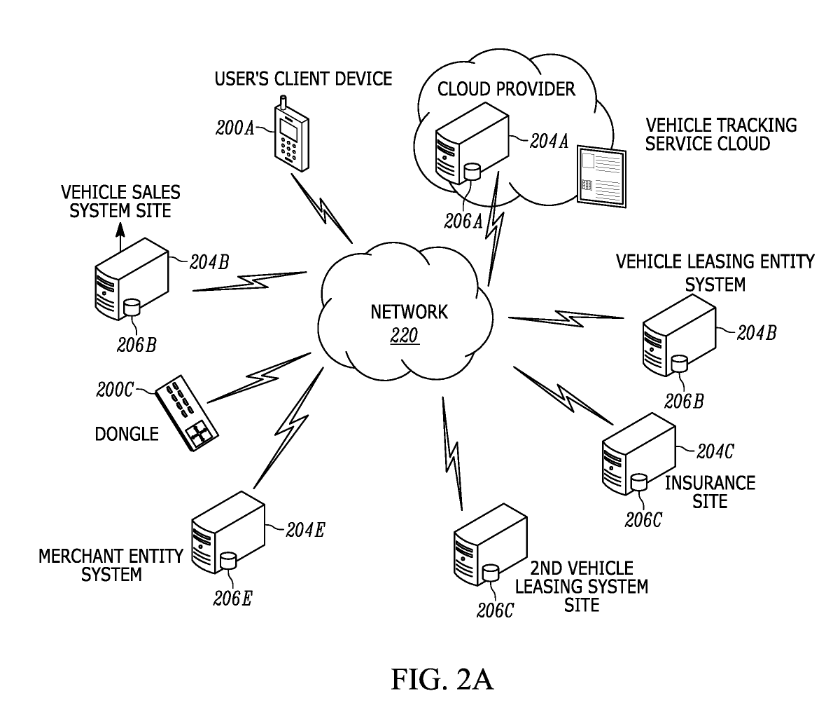

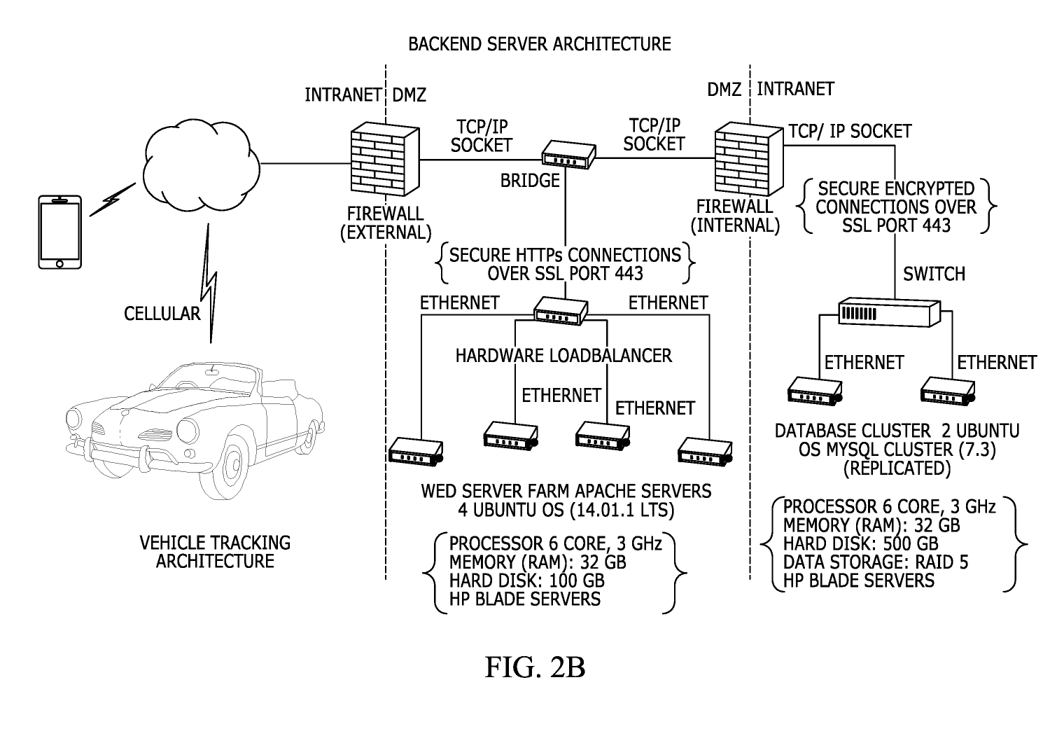

In general, the remote access system to a vehicle uses a backend cloud-based provider site. The following drawings and text describe various example implementations of the design. FIG. 2A and FIG. 2B illustrate example environments to implement the concepts for services, such as i) usage-based vehicle leasing, ii) a certified life-expectancy of a vehicle, iii) insurance and/or leasing incorporating actual driver performance, and iv) other similar services using a dongle module installed in a vehicle.

An aspect of the design is generally concerned with an automated system for driver scoring and reporting that maintains a performance history associated with particular drivers in stored database of multiple drivers. Another aspect is generally concerned with an automated system for tracking actual operation of the vehicle as well as maintenance performed on the vehicle to determine the estimated percentage of life remaining with this vehicle. The backend database stores the records of multiple vehicles. Services, such as i) usage-based vehicle leasing and ii) a certified life-expectancy of a vehicle, can use raw vehicle data and enriched vehicle data captured in a dongle module in the vehicle to determine the expected life remaining of that vehicle.

In general, a dongle module may track the actual operation of a vehicle as well as maintenance performed on the vehicle with the dongle module installed in the vehicle to determine an estimated percentage of life remaining with this vehicle. The dongle module may send data associated with the tracking of the actual operation of the vehicle as well as maintenance performed on the vehicle over a network to a server, which processes and then stores this data in one or more databases. The server may issue a certificate indicating the estimated percentage of life remaining with this vehicle based on the actual operation data and maintenance data from this vehicle. Any of i) a leasing rate of a vehicle and ii) a resale value of the vehicle may be determined based on the issued certificate indicating the estimated percentage of life remaining with this vehicle.

Likewise, a dongle module may track a driver's actual operation of a vehicle with the dongle module installed in a vehicle to determine a driver's history report. The dongle module may send data associated the tracking of the actual operation of the vehicle over a network to a server, which processes and then stores this data in one or more databases. The server may issue a driver's scoring report based on the actual operation data from this vehicle. Any of i) a leasing rate of the vehicle and ii) an insurance amount charged for driving this vehicle may be determined based on the driver's scoring report.

A driver history report may include many factors to express performance or quality of the driver's operation of a vehicle. Note, a vehicle operation history report may include many of these same factors to capture the raw vehicle data and enriched vehicle data to determine the certified life-expectancy of that vehicle based on the actual operation and maintenance of that vehicle. Concepts discussed for the driver history report can be similarly applied in the usage-based vehicle leasing embodiment and the certified life-expectancy of a vehicle embodiment, and vice versa.

A driver history report is a report containing statistical information regarding the performance of a driver and/or their vehicle operation. Note, a very similar vehicle operation report is generated for that vehicle in i) the usage-based vehicle leasing embodiment and ii) the certified life-expectancy of a vehicle embodiment. A driver history report and/or a vehicle operation report is an output from an analyzer module. The analyzer module applies any of a prescribed group of algorithms to a plurality of event record dataset records in which some those datasets having been created over some extended period of time. Thus, a driver history report is a historical account of events having occurred with particular connection to a certain driver or vehicle. The vehicle events that may occur from time-to-time result in production of data describing and documenting the event. The data may be associated with a particular driver's identity and stored over time. An analyzer module applies certain algorithms to data recalled from memory to produce a statistical report. A driver history report and/or a vehicle operation report is therefore a compilation of analyzed data to produce results that expresses the historical nature of a driver's and/or vehicle's operation and maintenance. A driver history report and/or a vehicle operation report may be based upon all events captured over a specified period of time and is sometimes comprised of a plurality of weighted factors.

Services, such as usage-based vehicle leasing and certified life-expectancy of a vehicle, can use raw vehicle data and enriched vehicle data and algorithms to determine the expected life remaining of a vehicle. The raw vehicle data is directly captured in the vehicle operation report and sent to the backend server for further analysis. Similarly, enriched vehicle data is captured by the dongle module manipulated and/or combined into a packaged set of related information by the connector module and/or analyzer module in the dongle module and then included in the vehicle operation report.

Vehicle operating data can be 1) obtained from the vehicle's onboard diagnostics module both at level 1 vehicle data and level 2 vehicle data from the CAN bus and 2) obtained from wirelessly from other vehicle sensors. Vehicle operating data is stored in the dongle module and then a communication circuit in the dongle module sends the raw and enhanced vehicle operating data in the report to the backend server in order for the algorithms to calculate the life of the components of the car. The algorithms are configured to calculate the life of the components of the car by comparison to historical and engineering charts and tables on each component's life based on use usage and exposure to certain vehicle handling operations. After looking at the expected life of each of the vehicle's components, the life expectancy ultimately of the vehicle can be calculated. The backend server may generate a certificate of vehicle-life expectancy based on actual operation of this vehicle and maintenance on this vehicle. Thus, the certificate of vehicle-life expectancy is generated based on the raw data and enhanced data collected by the dongle module and then sent to the backend server. The vehicle may be a car, truck, motorcycle, and other similar vehicle.

The certificate of vehicle-life expectancy allows buyers and sellers of the vehicles to better know and determine the value of a car. Alternatively, the dollar amount of the lease per month can be based on the actual usage of the car based on the enriched and raw data of the vehicles operation. A driver who treats a vehicle gentler with less breaking and not as heavy city miles will have a leased vehicle with more expected life of the vehicle. Accordingly, a gentler driver will pay less dollars per month for the usage-based lease, than an aggressive driver who accelerates fast, decelerates fast, and puts heavy city miles on the vehicle. The actual vehicle operation data gives much more informed and valuable information than simply a Kelly Bluebook's value of the vehicle based solely on total miles driven and estimated condition of the vehicle.

Additionally, the total amount of miles on the vehicle could also be more accurately classified. For example, the total amount of miles on the vehicle could be more accurately classified as a certain percentage of highway miles, based on speed and breaking rate of the vehicle, such as 75% of these total miles are highway miles and 25% of the miles on the vehicle are city miles. By knowing the actual operation of the vehicle's temperatures, breaking rate, acceleration rate, the actual highway miles and city miles, etc., removes the guesswork on how much vehicle life is remaining on the vehicle rather than just based on some abstract total miles of a vehicle.

By knowing the actual operation of the vehicle, the backend server is configured to compare the operation of the vehicle under these conditions and parameters, and then the algorithms may determine the actual estimated life left in the vehicle. Based on this, the backend server will issue a certificate of actual estimated amount life left for the vehicle and/or issue a report on actual estimated amount life left each month and supply that information to a leasing company in order to determine how much the driver should pay for lease.

Adjustments to the lease can be made based upon the certified driving profile and actual usage of the vehicle. The usage-based lease can be adjusted up or down, for example, every three months or every six months, based on the actual use of that vehicle data captured by the dongle module. The usage based vehicle lease rate is possibly frontloaded and then the monthly lease amount becomes less and less; or alternatively, the lease amount may be low and then go up based upon the actual use and operation of the vehicle based on its actual recorded parameters and data. In an embodiment, the driver history report may be sent to either, for example, a vehicle leasing company in addition to the vehicle operation report and/or sent to an insurance company to determine this driver's insurance cost based on the history of actual driver. Again, the vehicle operation report may be used to determine the percentage of expected life of that vehicle and other similar uses.

The raw and or enhanced data may be sent back to the backend server and stored and in its databases under the VIN of that vehicle. The backend server having data from multiple vehicles of the same make and model may make additional analysis and comparisons based on the local aggregated data.

The analyzer module functionality may be implemented in the dongle module, in the backend server, combined between both devices, and/or have overlapping functionality in both devices. The dongle module may plug into an on-board diagnostic module or other connection point to integrate with the vehicle's systems. The analyzer module of the dongle module looks that factors of vehicle operation, including speed, acceleration, deceleration, etc., and vehicle maintenance, such as oil changes, and other vehicle diagnostic parameters that the dongle module can get off the CAN bus. Some of the other vehicle diagnostic parameters can include whether a collision has occurred on the vehicle based on the deceleration rate being greater than, for example, a threshold amount.

Multiple vehicle operation recorders in the dongle module are coupled to vehicle systems, including its onboard diagnostic module. A connector module may form an association between collected data and the driver in command of the vehicle. The dongle module may contain a memory system for long-term storage of data in a structure that preserves the association between a driver of the vehicle and event records attributed to that driver.

The dongle module is configured to gather automatically collecting and processing data over time on a driver and the vehicle status to determine a driver's performance history recording in its memory. A similar operation occurs with the vehicle's operation. The dongle module automatically, via a set of algorithms and routines, collects and processes data over time to form a driver history report and/or a vehicle operation report including performance information collected over a discrete time period. A vehicle operation recorder in the dongle module is an electronic instrument coupled to the vehicle and its environments to capture data in the long term memory in response to 1) a detected exception or 2) to a prescribed condition or 3) to another ‘event’. Onboard diagnostics modules level 2 data from the CAN bus and other buses or vehicle sensors can be captured into long-term memory and sent to the back and server.

The vehicle operation data can be captured from the on board analyzer module as well as additional applications running on the dongle module to record and/or allow the logging of various vehicle maintenance operations occurring on the vehicle. The dongle module can connect into the onboard diagnostics port and communicate to a mobile phone via Bluetooth to an application running on the mobile phone. Alternatively, the dongle module can also can use the cellular network to communicate with the server back end. The analyzer module may also be configured to understand diagnostic codes and other vehicle codes used standardly in the vehicle, by referencing the make and model of the vehicle to understand the codes.

The backend server receives data from multiple vehicles and stores the vehicle data in a database. The backend server receives data from each vehicle and associates that vehicle's make, model, and VIN to the data from that vehicle, and then stores the vehicle data for the multiple cars in the back in database. The backend server can perform further analysis on the received data. The backend server can come along and reference the database and each VIN in order to do analysis on the different parameters captured in each vehicle in order to calculate expected life left on each component and by extension the life of the vehicle. Life of the vehicle can be used for many purposes such as issuing a certificate of how much expected life is left for a vehicle, as well as usage based vehicle leasing to determine the dollar amount per month of how much the driver should pay for leasing that vehicle.

The dongle module cooperates with a diagnostic system for a recording operation and generating a database grid of multiple separate dataset records each associated with a vehicle event occurring at a different time. The grid of multiple separate dataset records can be associated with a unique driver such as “Jose”. Likewise, the data set record can be associated a vehicle event like a crash involving a rapid declaration of the vehicle. The event data records include vehicle information relating to, for example, vehicle speed, GPS data, breaking rate, and whether the event involves an accident. In addition, the date, time, and duration of the event is recorded and a ‘miles-year-to-date’ numeric value is included as part of the dataset. The data grid could certainly include many more data fields that contribute ultimately to the expression of an operator performance measure, for example: detailed speed data, braking and acceleration measurements, engine speed, steering position, and maintenance a vehicle. Systems are based upon analysis that may be applied to so captured organized and stored data to yield a driver performance measure which expresses the quality of a driver and/or an actual operation of the vehicle. All systems not having vehicle mounted trigger event data capture devices, rely on manual manipulation and management of information to arrive at similar descriptions of driver performance. All tracked drivers may soon benefit from these systems that operate to measure driver performance resulting in lower insurance costs and/or greater than average life expectancy left on the vehicle.

Each received event record data set is automatically assigned a unique identifier that maintains a connection between all fields or data elements of the record. While the data is in storage and under safekeeping at the database, a process loop resets the vehicle operation recorder in the dongle module to receive and convey additional event record datasets not related in time to the earlier received conveyance.

Systems on the dongle module includes a wireless communications link between a vehicle any remote network of server computers. In particular, a Wi-Fi type access points allows an analyzer module to communicate by way the Internet with a backend server computer hosting vehicle tracking service. The dongle may communicate with the onboard diagnostics module or with vehicle sensors directly such as an oxygen sensor and smog sensor for the automobiles that communicate with remote servers by way of a Wi-Fi communications links. Vehicle surveillance systems are used to provide records of events such as maintenance operations, rates of acceleration and deceleration, miles driven, miles driven on highway settings without long period of being in idle and city miles with long periods of being in idle and heavy repeated breaking, incidents, happenings, et cetera. The dongle module is configured to monitor parameters of a vehicle's electronic control units to gather mechanical and electronic data regarding the operation of the vehicle sometime via the onboard diagnostics module and sometime with Wi-Fi with the cars sensors, and sometime via additional installed wiring to vehicle sensors. A short term detection technique contemplates storing a current time value at regular intervals during periods of operation of the vehicle in which the recording device. A plurality of sensors for registering vehicle operation parameters are included for sensing storing and updating operational parameters. A rewritable, nonvolatile memory is provided for storing those processed operational parameters, which are provided by the microprocessor controller. Data is converted to a computer readable form and read by a computer such that an accident can be reconstructed via data collected. The mobile vehicle is continuously in contact by way of cellular communication networks with a remotely located host computer.

The dongle module may contain a cellular communication circuit to communicate this data for the driver history report to a backend server. In an embodiment, the communication circuit may use Bluetooth to connect with an app on mobile smart device such as a phone, which will then communicate the data to the back end server.

The analyzer module of the dongle module is configured such that the driver performance measure indicates one or more of how well the driver minimizes exposure to a risk of being in a vehicle accident, how well the driver minimizes an amount of fuel consumed while operating the vehicle, how well the driver maximizes a usable life of mechanical components of the vehicle, how well the driver meets expectations while performing scheduled tasks, or how well the driver meets any additional compliance standards and procedures associated with the vehicle. Special algorithm functions executed against stored data yields driver history reporting—including a single value performance score indicative of a driver's performance and safety history. Similarly, special algorithm functions can be executed against stored data yields of a known amount to calculate expected car life left in this particular vehicle based on the factors of how and where the vehicle has been driven and type of maintenance performed on the vehicle.

An analyzer module system operates to recall data, particularly data from a plurality of vehicle events associated with driver operator of the vehicle and/or the vehicle itself. The vehicle events are recorded over an extended period of time. Data is arranged such that mathematical analysis may be applied independently to various data elements or data “fields” to produce performance metrics and ratios that reflect performance.

A memory stores the vehicle information data from the vehicles sensors and onboard diagnostic module. The plurality of sensors may include a vehicle speed sensors, steering angle sensor, brake pressure sensor, acceleration sensor, are all directly coupled to a control unit in the dongle module or via the CAN bus. The Controller Area Network (CAN bus) is a vehicle bus standard designed to allow microcontrollers and devices to communicate with each other in applications without an intervening host computer. It uses a message-based protocol. Further, the control unit passes information to a flash memory and a RAM memory subject to an encoder. The information collected is passed through a video output terminal. This illustrates another hardwire system and the importance placed by experts in the art on a computer hardware interface. This is partly due to the fact that video systems are typically data intensive and wired systems are necessary as they have bandwidth sufficient for transfers of large amounts of data.

A database system in communicative relation with an analyzer module conveys result set to the analyzer module for application of algorithms and mathematical analysis. In some versions, the analyzer module sends queries into the database system or calls stored procedures therein which may be executed to produce highly directed results sets. A final process may be initiated where an output action is taken. In a simple first example of an output action, a report is produced where the report includes an operation performance measure.

The event record dataset can be stored with a unique identifier via an index scheme whereby the data can be sorted and processed as distinguishable from all similar records. To a collection of event records so stored in the database mathematical analysis may be applied to produce an output to a display in the vehicle, display on a smart phone, or other external system.

The vehicle recorder method can start in response to an event trigger of a vehicle operation recorder in the dongle module that indicates the occurrence of an exception. Each vehicle operation recorder may be configured to record a separate parameter or set of parameters.

The dongle module may use a number of methods and systems for detecting the vehicle's location using global positioning system circuitry in a smart phone, via a blue tooth connection to the driver's phone or via a GPS circuit built into the dongle module. A GPS receiver may communicate with the wireless technology to automatically report associate the vehicle's location with recorded vehicle data events. The system may use the GPS signals to determine when a deceleration value of a vehicle exceeds the preset threshold which is meant to be indicative of an accident having occurred.

The communications circuit of the dongle module may report automobile performance parameters in the report to remote servers via wireless links. Specifically, an onboard data bus of the OBD system is coupled to a microprocessor of the dongle module, by way of a standard electrical connector. The microprocessor periodically receives data, analyzes the data to classify or make logical associations, and transmits the vehicle into the wireless communications system for remotely characterizing the vehicle performance. Data of the OBD system is periodically received by a microprocessor and passed into a local transmitter. The dongle module calls out transmission of data on a predetermined time interval as well as based on amount of data collected. The dongle module processes and analyzes the data being passed into a local transmitter.

Vehicle operation information is kept in long-term storage where it may be joined by data from events occurring at a later time. An analyzer module system operates to recall the vehicle operation information data, and potentially associates some of the vehicle operation information data with a single operator. Data is arranged in a manner such that algorithms and other mathematical analysis may be applied independently to various data elements or “fields” to produce performance metrics and ratios. Together, these factors may each be weighted and summed in accordance with specially devised a formula including those having a single value solution. In an embodiment, this performance score may be normalized to a value between one and nine, where values closer to one represent the best operators enrolled in the program and values nearer nine reflect those operators of lowest performance. Thus, these systems provide a highly useful metric that quantifies operator performance history. Based on this metric and the other fields for performance metrics an insurance company may use this information to determine a business decision, such as how much this driver should be charged for insurance.

The dongle module is configured with circuits and software to provide automated driver as well as vehicle operation performance measure, recording and reporting systems. The dongle module is configured with circuits and software to provide automated driver performance as well as vehicle operation tracking and history systems.

Discrete value data is also collected from the electronic detectors coupled to vehicle subsystems. Data, which characterizes the event, is assembled together as an information packet to form an event record. The event record is passed to the connection module. Aside from this process, additional information is prepared and passed into the connection module. In some versions, a user input is received for example at a login keypad or smartcard reader, that user input specifying an authorized operator identity. A coded input prearranged with an association to a particular driver is received to alert the system as to the identity of the driver. An authorization check may be used to verify a valid code. The current driver identity is conveyed to the connection module any time an event occurs such that it may be appropriately combined with and connected to the event data. The connection module modifies the event record by adding operator and sometimes vehicle identity information thus forming an association there between to form an event record dataset. The dataset is arranged in a form suitable for cooperation with relational database structures including data type and indices considerations such that when conveyed to the database via an “insert” operation, the data is placed in table(s) as one of a plurality of similarly arranged records. The preceding portion of the method may be executed repeatedly in a loop to effect capture of many event record datasets that each has its own association with a particular single.

In an embodiment, analysis of collected data occurs. An analyzer module is arranged to read database records and process them to arrive at a result that is based upon the information contained therein especially as it applies to a particular driver. The system is extremely powerful in-part because it can consider a plurality of event records each associated with a different event but identical operator. Accordingly, these analyses yield valuable performance indicators that relate to a driver and/or actual operation of the vehicle.

The analyzer module supplies an output to a graphical user interface on a display of the smart phone and/or vehicle display panel, whose state can used by the vehicle driver's controls how the analysis is taken up. A database query is formed and transmitted over a communications link to the database where the query may be applied against the stored data. After execution of the query, the database produces a result set and conveys that back to the analyzer module as a query response.

From the input at the database, an appropriate algorithm is selected and applied to the result set to further process the data. One important aspect includes forming a driver history report that reflects the quality of performance by a single or selected group of drivers. In addition to a compound report that may include many separate factors, a single value performance score can be computed. Separate performance measures are combined via weighted coefficients to arrive at a normalized single-value score. The score is particularly valuable because it is easily standardized and permits a relative basis upon which all participating drivers may be accurately compared. For example, highest performance driver in the system may be assigned a score of 9 and all others some value between 9 and 0 to reflect their performance in relation to the system the universe of operators.

A driver performance measure may be provided by a system having a connection module; a data store; and an analyzer module. The connection module ‘connects’ or forms an association between event records and an operator identity as part of a dataset, which is transmitted to the data store. An analyzer module is arranged to apply mathematical processing and analysis against stored datasets to produce a driver performance measure.

In a vehicle operation recorder in the dongle module, a vehicle event results in the capture of information that may be used to characterize the event and status of the vehicle and operator. Once information relating to a particular event is captured, that information is associated with a particular driver to form a dataset suitable for long term storage in a database. Events taking place at a later time, which might be similarly stored, may include the same driver. As such, it is possible to run a statistical analysis on all events associated with a particular driver and to draw performance algorithms that yield a performance measure type result. For example, a first performance measure might simply include the number of events occurred per mile driven. Another performance indicator might be number of crash type incidents per mile driven. A more complex algorithm might include both of these measures and a weighting factor for each. For example: performance measure=(Events/Mile)*4+(Crashes/Mile)*7; where 4 and 7 are weighting factors.

As such, an connection module is a subsystem arranged to form a connection between information captured in an event and information which uniquely identifies a driver; namely the driver responsible for the vehicle at the time of the event—a logged on driver. A connection module comprises a logic processor arranged to receive both event data information and operator identity information and to assemble that information according to protocol demanded at a database. A database record structure having a one-to-one correspondence between events and drivers is an example of an enforced relationship in such record structures prepared by a connection module.

An analyzer module is provided with a priori knowledge of these data structures such that it might execute machine operations against stored data which effect analysis on several event records; each of which may be associated with a particular driver or driver group. An analyzer module might include: a graphical user interface; a query facility; and an algorithm library as part of its subsystems. The graphical user interface can be arranged to: receive inputs from a user; to drive query formation in agreement with received inputs; and further to select algorithms from the algorithm library. In this way, an analyzer module reads and processes stored event data to formulate a result which is a driver performance measure.

These systems for producing a driver performance measure may include a set of electronic transducers coupled to several of the vehicle environments and systems to capture information relating to vehicle operation or performance. Outputs from these electronic transducers are assembled together in an ‘information package’ together as event records which may be taken up by the connection module. By example, these sensors may include any of those from the group: imager; accelerometer; speedometer; position; orientation; time; and any of standard vehicle systems status indicators including: engine speed, temperature; braking; gear ratio; and steering wheel position.

Many additional analysis steps may occur.

A ‘receiving an event record’ step where a vehicle operation recorder in the dongle module captures information relating to a declared vehicle event, i.e. in response to a trigger; for example a video record of environments about a subject vehicle and sensor data relating to a vehicles systems. A ‘receiving identity information’ step is performed where a discrete indication of a particular driver, or a unique identifier assigned to a particular vehicle or vehicle fleet, is received at a connection module where the connection module performs the next step.

A ‘forming an association’ step connects the event record with received driver identity information thus forming a dataset record having: event record, identity information, and the association there between. A well-formed database record might include: event record information, identity information, and an association there between. The database record includes a plurality of field elements, each field element having a prescribed data type and value assigned thereto, the values reflecting information received as an event record and identity information.

Further, the steps include storing the dataset record in a database for long term storage; ideally, for a term long enough where other event records are also added to the database. Each dataset record has information from an event record captured at a time different than the capture time of all other dataset records.

Dataset records are recalled in a query step where they may be sorted and selectively chosen in accordance with an index—for example, all event records of the month of September associated with a certain driver. Upon the carefully selected records recalled as described, a mathematical analysis may be applied to produce an output that might reflect a driver's performance and/or % expected life remaining on the vehicle. Executing an algorithm to realize a ratio between the resultant of two algorithms applied to two different field elements.

A mathematical analysis is applied in a method step directed to address any plurality of event records. A prescribed algorithm arranged to effect a ratio between any two field elements is particularly useful in expressing some driver performance measures and those are explicitly part of these teachings. A ratio with a time based unit in the denominator is exemplary. For example, the “number of infractions per year” is a ratio of considerable importance for expressing a driver performance. Another is “number of infractions per mile”. Of course, reciprocals are equally effective in expressing the same information and are considered included alternatives.

Results from mathematical analysis may be expressed in several ways including real-time graphical display, printed reports, as inputs to triggers. Thus, methods of these inventions include ‘providing an output report’ step is further characterized as a report having a plurality of resultants produced by application of the mathematical analysis.

A driver performance report of particular importance includes a single-value performance coefficient, which is derived from the results of and plurality of analysis. Weighted coefficients applied to algorithm resultants form basis for such single-value output in best arrangements.

Aspects of the design may be used for driver scoring and reporting that maintains a performance history associated with particular drivers in stored database. Aspects of the design may be used for tracking actual operation of the vehicle as well as maintenance performed on the vehicle to determine the estimated percentage of life remaining with this vehicle. Services, such as i) usage-based vehicle leasing and ii) a certified life-expectancy of a vehicle, and iii) driver performance can use the vehicle to determine the expected life remaining of that vehicle.

### Revenue

The user/customer of the vehicle may pay an additional fee on a per vehicle access instance to use the dongle module to a backend-server vehicle service. The user/customer may pay a monthly or yearly subscription fee for all these vehicle services. The user/customer may pay on another usage case model. Alternatively, a revenue sharing agreement may be in place between the vehicle leasing companies, the vehicle insurance companies, and the backend server provider. These service providers, such as the vehicle leasing companies, the vehicle insurance companies, may subsidize the vehicle services.

### Computing System

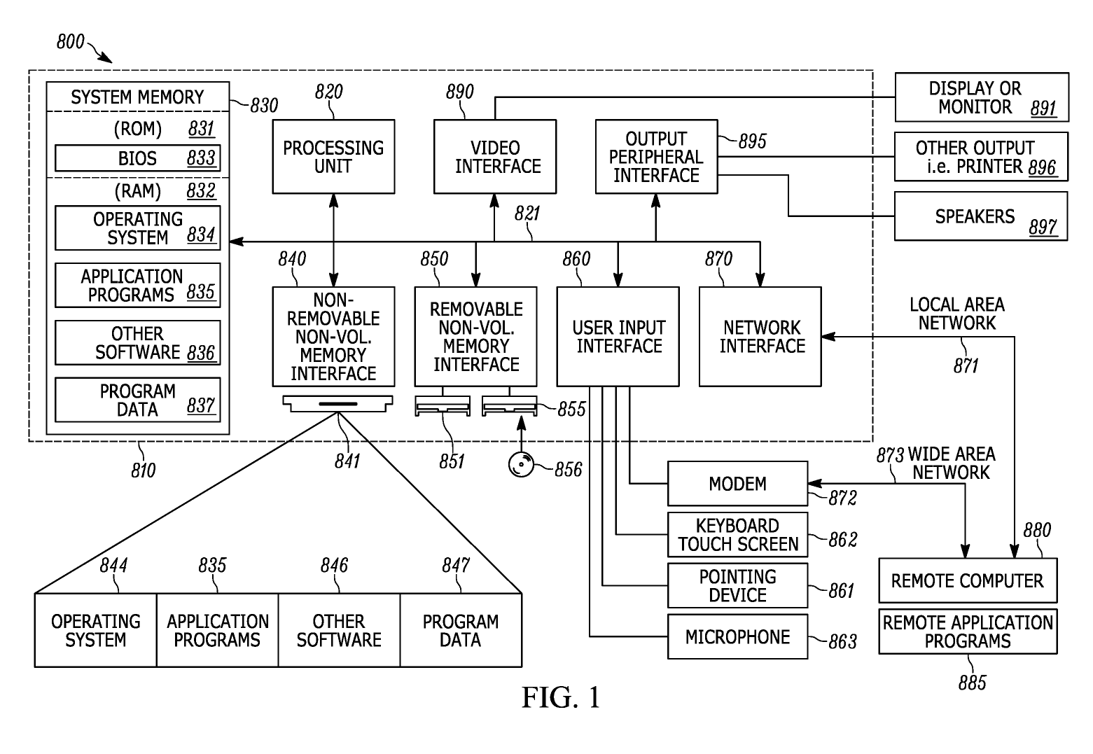

FIG. 1 illustrates a block diagram of an example computing system that may be used in an embodiment of one or more of the servers, in-vehicle electronic modules, and client devices discussed herein. The computing system environment 800 is only one example of a suitable computing environment, such as a client device, server, in-vehicle electronic module, etc., and is not intended to suggest any limitation as to the scope of use or functionality of the design of the computing system 810. Neither should the computing environment 800 be interpreted as having any dependency or requirement relating to any one or combination of components illustrated in the exemplary operating environment 800.

With reference to FIG. 1, components of the computing system 810 may include, but are not limited to, a processing unit 820 having one or more processing cores, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing system 810 typically includes a variety of computing machine readable media. Computing machine readable media can be any available media that can be accessed by computing system 810 and includes both volatile and nonvolatile media, removable and non-removable media. By way of example, and not limitation, computing machine readable mediums uses include storage of information, such as computer readable instructions, data structures, other executable software or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computing device 800. However, carrier waves would not fall into a computer readable medium. Communication media typically embodies computer readable instructions, data structures, program modules, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computing system 810, such as during start-up, is typically stored in ROM 831. RAM 832 typically contains data and/or program modules that are immediately accessible to and/or presently being operated on by processing unit 820. By way of example, and not limitation, FIG. 1 illustrates operating system 834, other software 836, and program data 837.

The computing system 810 may also include other removable/non-removable volatile/nonvolatile computer storage media. By way of example only, FIG. 1 illustrates a hard disk drive 841 that reads from or writes to non-removable, nonvolatile magnetic media nonvolatile optical disk 856 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 1, provide storage of computer readable instructions, data structures, other software and other data for the computing system 810. In FIG. 1, for example, hard disk drive 841 is illustrated as storing operating system 844, other software 846, and program data 847. Note that these components can either be the same as or different from operating system 834, other software 836, and program data 837. Operating system 844, other software 846, and program data 847 are given different numbers here to illustrate that, at a minimum, they are different copies.

A user may enter commands and information into the computing system 810 through input devices such as a keyboard 862, a microphone 863, a pointing device 861, such as a mouse, trackball or touch pad. The microphone 863 may cooperate with speech recognition software. These and other input devices are often connected to the processing unit 820 through a user input interface 860 that is coupled to the system bus, but may be connected by other interface and bus structures, such as a parallel port, game port or a universal serial bus (USB). A display monitor 891 or other type of display screen device is also connected to the system bus 821 via an interface, such as a video interface 890. In addition to the monitor, computing devices may also include other peripheral output devices such as speakers 897 and other output device 896, which may be connected through an output peripheral interface 890.

The computing system 810 may operate in a networked environment using logical connections to one or more remote computers/client devices, such as a remote computing device 880. The remote computing device 880 may be a personal computer, a hand-held device, a server, a router, a network PC, a peer device or other common network node, and typically includes many or all of the elements described above relative to the computing system 810. The logical connections depicted in FIG. 1 include a local area network (LAN) 871 and a wide area network (WAN) 873, but may also include other networks. Such networking environments are commonplace in offices, enterprise-wide computer networks, intranets and the Internet. A browser application may be resident on the computing device and stored in the memory.

When used in a LAN networking environment, the computing system 810 is connected to the LAN 871 through a network interface or adapter 870. When used in a WAN networking environment, the computing system 810 typically includes a modem 872 or other means for establishing communications over the WAN 873, such as the Internet. The modem 872, which may be internal or external, may be connected to the system bus 821 via the user-input interface 860, or other appropriate mechanism. In a networked environment, other software depicted relative to the computing system 810, or portions thereof, may be stored in the remote memory storage device. By way of example, and not limitation, FIG. 1 illustrates remote application programs 885 as residing on remote computing device 880. It will be appreciated that the network connections shown are exemplary and other means of establishing a communications link between the computing devices may be used.

As discussed, the computing system may include a processor, a memory, a built in battery to power the computing device, an AC power input, potentially a built-in video camera, a display screen, a built-in Wi-Fi circuitry to wirelessly communicate with a remote computing device connected to network.

It should be noted that the present design can be carried out on a computing system such as that described with respect to FIG. 1. However, the present design can be carried out on a server, a computing device devoted to message handling, or on a distributed system in which different portions of the present design are carried out on different parts of the distributed computing system.

Another device that may be coupled to bus 811 is a power supply such as a battery and Alternating Current adapter circuit. As discussed above, the DC power supply may be a battery, a fuel cell, or similar DC power source that needs to be recharged on a periodic basis. The wireless communication module 872 may employ a Wireless Application Protocol to establish a wireless communication channel. The wireless communication module 872 may implement a wireless networking standard such as Institute of Electrical and Electronics Engineers (IEEE) 802.11 standard, IEEE std. 802.11-1999, published by IEEE in 1999.

Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

### Vehicle's Intelligent Transport Systems to Integrate with a Connected Network Environment

A vehicle has hardware and software that can take control of the vehicle for a short period including activating electromechanical mechanisms that are part of the vehicle. The vehicle has hardware and software for networking between the cloud as well as potentially between other vehicles to cause related automation within the vehicle based on communications between the vehicle and the cloud and/or other vehicles. The vehicle's Cellular Interface system is configured to allow cellular phones access the automobile computer systems, interpret the information and show the text on the cellular phones display while simultaneously transmitting the retrieved information, as well as characteristic and states of the cellular phone used to access the vehicle computer system, to a global network that would alert parties who could assist or benefit from the retrieved automobile information. A cellular phone with a software application can establish a connection with the vehicle's on-board diagnostic computer and/or other on-board intelligent control systems.

The system can interface with a client device, such as a mobile phone, with the on-board computing system in the vehicle. The on-board diagnostic computing device may monitor a set of operational characteristics of a vehicle and communicate that diagnostic to both the driver and with the cloud. The information derived from this system can also be conveyed and processed on a mobile client device coupled with additional information and displayed on the mobile client device's display screen, while simultaneously transmitting this information over the Internet to be stored in a database.

At the point of communication negotiation, an application on the client device extracts position location from the vehicle's navigation system and transmits the response from the vehicle's navigation system and the location to a server ready to receive this information. Alternatively, an application can extract similar position information from GPS module internal to the client device itself.

In an embodiment, the standard for the automotive industry for vehicles may use is the SAE J1850 communications protocol, which utilizes variable pulse width modulation and pulse width modulation. This means that the width of the pulse determines whether it is a 1 or a 0. Most phones form communication with serial connections (RS-232, Infrared . . . etc.) and wireless connection protocols (Bluetooth, Infrared . . . etc.). These two protocols must be converted or bridged by some sort of microprocessor so the two communication methodologies can communicate with each other. This can be accomplished by using an integrated circuit that can be used to convert the OBD-II signal (which includes different protocols such as, but not limited to: J1850 VPW, J1850 PWM, ISO 9141-2, ISO 14230, ISO 15765) to one of the aforementioned phone communication formats.

### Network Environment

FIG. 2A and FIG. 2B illustrate diagrams of a network environment in which the techniques described may be applied. The network environment 200 has a communications network 220 that connects server computing systems 204A through 204E, and at least one or more client computing systems 202A, 202B. As shown, there may be many server computing systems 204A through 204E and many client computing systems 202A through 202B connected to each other via the network 220, which may be, for example, the Internet. Note, that alternatively the network 220 might be or include one or more of: an optical network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 202A and the server computing system 204A can both initiate and respond to communications, their communication may be viewed as peer-to-peer. Likewise, communications between the client computing systems 204A and 204-2, and the server computing systems 202A and 202B may be viewed as peer-to-peer if each such communicating device is capable of initiation and response to communication. Additionally, server computing systems 204A-204E also have circuitry and software to communication with each other across the network 220. One or more of the server computing systems 204A to 204E may be associated with a database such as, for example, the databases 206A to 206E. Each server may have one or more instances of a virtual server running on that physical server and multiple virtual instances may be implemented by the design. A firewall may be established between a client computing system 200A and the network 220 to protect data integrity on the client computing system 200A. Each server computing system 204A-204E may have one or more firewalls.

FIG. 2A and FIG. 2B illustrate block diagrams of an embodiment of a cloud-based remote access to a vehicle service hosted on the cloud-based provider site that automates a service like a package delivery to and pick up from the vehicle process. The cloud-based remote access to a vehicle service is hosted on a cloud-based provider site that contains one or more servers and one or more databases.

A cloud provider service can install and operate application software in the cloud and users can access the software service from the client devices. Cloud users who have a site in the cloud may not solely manage the cloud infrastructure and platform where the application runs. Thus, the servers and databases may be shared hardware where the user is given a certain amount of dedicate use of these resources. The user's is given a virtual amount of dedicated space and bandwidth in the cloud. Cloud applications can be different from other applications in their scalability—which can be achieved by cloning tasks onto multiple virtual machines at run-time to meet changing work demand. Load balancers distribute the work over the set of virtual machines. This process is transparent to the cloud user, who sees only a single access point.

The cloud-based remote access to a vehicle service is coded to utilize a protocol, such as Hypertext Transfer Protocol (HTTP), to engage in a request and response cycle with both a mobile device application resident on a client device as well as a web-browser application resident on the client device. The cloud-based remote access to a vehicle service has one or more routines to automate a package delivery to and pick up from the vehicle process. The cloud-based remote access to a vehicle service can be accessed by a mobile device, a desktop, a tablet device and other similar devices, anytime, anywhere. Thus, the cloud-based remote access to a vehicle service hosted on a cloud-based provider site is coded to engage in 1) the request and response cycle from all web browser based applications, 2) SMS/twitter based request and response message exchanges, 3) the request and response cycle from a dedicated on-line server, 4) the request and response cycle directly between a native mobile application resident on a client device and the cloud-based remote access to a vehicle service, and 5) combinations of these.

The cloud-based remote access to a vehicle service has one or more application programming interfaces (APIs) with two or more of the package delivery entity sites, such as FedEx, UPS, etc., as well as application programming interfaces with two or more of the OEM ‘remote access/connectivity’ systems, such as telematics system sites, such as OnStar, Lexus Linksys, Ford Sync, Uconnect, MBConnect, BMWConnect, etc. The remote access to a vehicle service may have additional APIs. The APIs may be a published standard for the connection to each OEM ‘remote access/connectivity’ system. The APIs may also be an open source API. One or more of the API's may be customized to closed/non-published APIs of a remote access/connectivity' site and/or package delivery entity site. The cloud-based remote access to a vehicle service is coded to establish a secure communication link between each package delivery entity site and the cloud provider site. The cloud-based remote access to a vehicle service is coded to establish a secure communication link between each telematics system site and the cloud provider site. The software service is coded to establish the secure communication link by creating a tunnel at the socket layer and encrypting any data while in transit between each package delivery entity sites and the provider site as well as to satisfy any additional authentication mechanisms required by the direct lending institution, including but not limited to IP address white listing and token based authentication.

In an embodiment, the server computing system 204 may include a server engine, a web page management component, a content management component and a database management component. The server engine performs basic processing and operating system level tasks. The web page management component handles creation and display or routing of web pages or screens associated with receiving and providing digital content and digital advertisements. Users may access the server-computing device by means of a URL associated therewith. The content management component handles most of the functions in the embodiments described herein. The database management component includes storage and retrieval tasks with respect to the database, queries to the database, and storage of data.

An embodiment of a server computing system to display information, such as a web page, etc. An application including any program modules, when executed on the server computing system 204A, causes the server computing system 204A to display windows and user interface screens on a portion of a media space, such as a web page. A user via a browser from the client computing system 200A may interact with the web page, and then supply input to the query/fields and/or service presented by a user interface of the application. The web page may be served by a web server computing system 204A on any Hypertext Markup Language (HTML) or Wireless Access Protocol (WAP) enabled client computing system 202A or any equivalent thereof. For example, the client mobile computing system 202A may be a smart phone, a touch pad, a laptop, a netbook, etc. The client computing system 202A may host a browser to interact with the server computing system 204A. Each application has a code scripted to perform the functions that the software component is coded to carry out such as presenting fields and icons to take details of desired information. Algorithms, routines, and engines within the server computing system 204A take the information from the presenting fields and icons and put that information into an appropriate storage medium such as a database. A comparison wizard is scripted to refer to a database and make use of such data. The applications may be hosted on the server computing system 204A and served to the browser of the client computing system 202A. The applications then serve pages that allow entry of details and further pages that allow entry of more details.

### Telematics System

The telematics system uses telecommunications, vehicular technologies, electrical sensors, instrumentation, and wireless communications modules to allow communication with between the cloud and a vehicle. The telematics system site sends, receives and stores information via a telematics module to affect control on objects in the vehicle. Telematics includes but is not limited to Global Positioning System technology integrated with computers and mobile communications technology in automotive navigation systems. Telematics also includes cloud-based interaction with an integrated hands-free cell phone system in the vehicle, wireless safety communication system in the vehicle, and automatic driving assistance systems.

A wireless communication circuit exchanges communication between the mobile client device and the vehicle. The wireless communication circuit executes instructions with the processor via a bus system. The wireless communication circuit can be configured to communicate to RF (radio frequency), satellites, cellular phones (analog or digital), Bluetooth®V, Wi-Fi, Infrared, Zigby, Local Area Networks (LAN), WLAN (Wireless Local Area Network), or other wireless communication configurations and standards. The wireless communication circuit allows the vehicle's intelligence systems such as the telematics module and other diagnostic tools to communicate with other devices wirelessly. The wireless communication circuit includes an antenna built therein and being housed within the housing or can be externally located on the housing.

The Telecommunications and Informatics applied in wireless technologies and computational systems may be 802.11p, the IEEE standard in the 802.11 family. This is also referred to as Wireless Access for the Vehicular Environment (WAVE), and is the primary standard that addresses and enhances Intelligent Transportation System.

An example telematics module sends commands and exchanges information other electronic circuits, electromechanical devices, and electromagnetic devices in the vehicle. The telematics module may operate in conjunction with computer-controlled devices and radio transceivers to provide precision repeatability functions (such as in robotics artificial intelligence systems) and emergency warning performance systems located in and exchanged between vehicles.

Additional intelligent vehicle technologies are car safety systems and self-contained autonomous electromechanical sensors to generate warnings that can be transmitted within a specified targeted area of interest, say within 100 meters of the emergency warning system for vehicles transceiver. In ground applications, intelligent vehicle technologies are utilized for safety and commercial communications between vehicles or between a vehicle and a sensor along the road.

The wireless communication circuits in the vehicle or in a client device are configured to give access to the mobile Internet via a cellular telephone service provider. The mobile Internet is wireless access that handoffs the mobile client device or vehicle from one radio tower to another radio tower while the vehicle or device is moving across the service area. Also, in some instances Wi-Fi may be available for users on the move so that a wireless base station connects directly to an Internet service provider, rather than through the telephone system.

### Scripted Code

In regards of viewing ability of an on-line site: the scripted code for the on-line site, such as a website, social media site, etc., is configured to adapted to be i) viewed on tablets and mobile phones, such as individual downloadable applications in data stores that are designed to interface with the on-line site, ii) viewable on a screen in the vehicle, as well as iii) viewable on a screen of a desktop computer via a browser. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like.

Mobile web applications and native applications can be downloaded from a cloud-based site. The mobile web applications and native applications have direct access to the hardware of mobile devices (including accelerometers and GPS chips), and the speed and abilities of browser-based applications. Information about the mobile phone and the vehicle's location is gathered by software housed on the phone.

One or more scripted routines for the cloud-based remote access to a vehicle service are configured to collect and provide features such as those described herein.

Any application and other scripted code components may be stored on a non-transitory computing machine readable medium which, when executed on the server causes the server to perform those functions. The applications including program modules may be implemented as logical sequences of software code, hardware logic circuits, and any combination of the two, and portions of the application scripted in software code are stored in a non-transitory computing device readable medium in an executable format. In an embodiment, the hardware logic consists of electronic circuits that follow the rules of Boolean Logic, software that contain patterns of instructions, or any combination of both.

The design is also described in the general context of computing device executable instructions, such as applications, etc. being executed by a computing device. Generally, programs include routines, objects, widgets, plug-ins, and other similar structures that perform particular tasks or implement particular abstract data types. Those skilled in the art can implement the description and/or figures herein as computer-executable instructions, which can be embodied on any form of computing machine readable media discussed herein.

Some portions of the detailed descriptions herein are presented in terms of algorithms/routines and symbolic representations of operations on data bits within a computer memory. These algorithmic descriptions and representations are the means used by those skilled in the data processing arts to most effectively convey the substance of their work to others skilled in the art. An algorithm/routine is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms/routine of the application including the program modules may be written in a number of different software programming languages such as C, C++, Java, HTML, or other similar languages.

Many online pages on a server, such as web pages, are written using the same language, Hypertext Markup Language (HTML), which is passed around using a common protocol—HTTP. HTTP is the common Internet language (dialect, or specification). Through the use of a web browser, a special piece of software that interprets HTTP and renders HTML into a human-readable form, web pages authored in HTML on any type of computer can be read anywhere, including telephones, PDAs and even popular games consoles. Because of HTTP, a client machine (like your computer) knows that it has to be the one to initiate a request for a web page; it sends this request to a server. A server may be a computing device where web sites reside—when you type a web address into your browser, a server receives your request, finds the web page you want, and sends it back to your desktop or mobile computing device to be displayed in your web browser. The client device and server may bilaterally communicate via a HTTP request & response cycle between the two.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

Although embodiments of this design have been fully described with reference to the accompanying drawings, it is to be noted that various changes and modifications will become apparent to those skilled in the art. Such changes and modifications are to be understood as being included within the scope of embodiments of this design as defined by the appended claims. The invention is to be understood as not limited by the specific embodiments described herein, but only by scope of the appended claims.

1. A method, comprising:
tracking actual operation of a vehicle as well as maintenance performed on the vehicle with a dongle module installed in the vehicle to determine an estimated percentage of life remaining with this vehicle;
sending data associated with the tracking of the actual operation of a vehicle as well as maintenance performed on the vehicle collected by the dongle module over a network to a server, which processes and then stores this data in one or more databases;
issuing a certificate indicating the estimated percentage of life remaining with this vehicle based on the actual operation data and maintenance data from this vehicle; and
determining any of i) a leasing rate of a vehicle and ii) a resale value of the vehicle based on the issued certificate indicating the estimated percentage of life remaining with this vehicle.

2) A method, comprising:
tracking a driver's actual operation of a vehicle with a dongle module installed in a vehicle to determine a driver's history report;
sending data associated the tracking of the actual operation of the vehicle collected by the dongle module over a network to a server, which processes and then stores this data in one or more databases;
issuing a driver's scoring report based on the actual operation data from this vehicle; and
determining any of i) a leasing rate of a vehicle and ii) an insurance amount charged for driving this vehicle based on the driver's scoring report.
